(19) United States
(12) Patent Application Publication
(10) Pub. No.: US 2016/0097301 A1
(43) Pub. Date: Apr. 7, 2016

(54) Aircraft gas turbine engine with shock-absorbing element for fan blade loss

(71) Applicant: Rolls-Royce Deutschland Ltd. & Co KG, Blankenfelde-Mahlow (DE)

(72) Inventors: Knut ROSENAU, Herzfelde (DE); Kai Navtej SINGH, Berlin (DE)

(21) Appl. No.: 14/876,435

(22) Filed: Oct. 6, 2015

(30) Foreign Application Priority Data
Oct. 7, 2014 (DE) 10 2014 220 317.1

(51) Int. Cl. F01D 25/06; F02C 7/06

(52) U.S. Cl. CPC F01D 25/06; F02C 7/06

(57) ABSTRACT

An aircraft gas-turbine engine having a fan mounted on a fan shaft and including several fan blades, where the fan shaft is mounted on an engine structure by means of an upstream fan bearing, when seen in the flow direction, and a downstream bearing, where at least one predetermined breaking point is provided in the area of the fan bearing, characterized in that at least one shock-absorbing element designed as metal fabric damper is arranged at a radial gap to have a parallel effect relative to the predetermined breaking point.

This invention relates to an aircraft gas-turbine engine in accordance with the features of the generic part of Claim 1.

In detail, the invention relates to an aircraft gas-turbine engine having a fan which is provided with several fan blades. The fan is mounted on an engine structure by means of a fan bearing. Loss of a fan blade or part of a fan blade results in an imbalance force, which is introduced into the engine structure via the fan bearing.

To permit absorption or compensation of the imbalance forces occurring, it is known from the state of the art, to provide at least one predetermined breaking point in the area of the fan bearing. This makes it possible for the fan or fan rotor to rotate about its new center of gravity. The resultant imbalance forces are however in this case introduced undamped into the bearing structure and then further into the engine suspension or engine structure and further into the aircraft structure. Not inconsiderable stresses occur here, which must be taken into account when designing the engine and aircraft structures.

The object underlying the present invention is to provide an aircraft gas-turbine engine of the type specified at the beginning which, while being simply designed and easily and cost-effectively producible, avoids the disadvantages of the state of the art and minimizes the introduction of undesired forces into the engine structure, in particular in the event of an imbalance of the fan.

It is a particular object of the present invention to provide solution to the above problematics by a combination of the features of Claim 1. Further advantageous embodiments of the present invention become apparent from the sub-claims.

It is thus provided in accordance with the invention that at least one shock-absorbing element is provided parallel to the at least one predetermined breaking point formed in the area of the fan bearing.

In normal operation of the aircraft gas-turbine engine, shocks and minor imbalances of the fan (fan rotor) are introduced into the engine structure via the fan bearing. These minor stresses do not disrupt normal operation. A fan blade loss, for example due to bird strike or similar, results however for the fan (fan rotor) in a new center of gravity which is radially offset relative to the engine axis. The resultant imbalance force destroys the predetermined breaking points at the fan bearing. It is thus provided in accordance with the invention that the imbalance force occurring at the fan bearing after the fan blade loss and breakage of the predetermined breaking points is damped at the fan bearing by the shock-absorbing element in accordance with the invention. This leads to a considerably lower introduction of force into the fan bearing structure, engine structure, engine suspension and/or aircraft structure.

The shock-absorbing element in accordance with the invention is arranged to have a parallel effect relative to the predetermined breaking points of the fan bearing and thus damps the rotating load peak of the imbalanced fan rotor. The shock-absorbing element damps in particular at the moment of the fan blade loss and for a subsequent period of time until the fan (fan rotor) has lost speed and hence energy and imbalance force.

The invention can be used preferably in existing engine designs, but can also be advantageously used in particular in aircraft gas turbines having an increased bypass flow ratio. The invention can also be used particularly advantageously in designs with an enlarged fan diameter in conjunction with a lower number of fan blades.

A further advantage of the solution in accordance with the invention is that it enables overall a more lightweight design of the entire fan bearing structure, engine structure, engine suspension and/or aircraft structure.

It is provided that the predetermined breaking point and the shock-absorbing element are arranged on the radially outer side of the fan bearing facing the engine structure. On the one hand this results in a space-saving overall design, and on the other hand it permits effective damping of the imbalance forces occurring.

The shock-absorbing element is designed in accordance with the invention in the form of a pressed metal fabric damper. These metal fabric dampers are known from industrial applications, for example for transformer bearings. Pressed metal fabric dampers can be used over a wide temperature range with a low variance in damping.

Depending on the size of the shock-absorbing element in accordance with the invention, it is possible to absorb between 20% and 50% of the imbalance force. The remaining imbalance force is introduced into the structure of the aircraft gas-turbine engine by a continuous deflection of the fan shaft or of a low-pressure shaft connected thereto and with low damping effect. Depending on the size and design of the shock-absorbing element, the damping of the imbalance force in the shock-absorbing element in accordance with the invention results in a reduction of between 5% and 20% in the imbalance force introduced into the structure compared with a solution according to the state of the art in which no shock-absorbing element is used.

It is provided that there is a radial gap between the fan bearing and the shock-absorbing element which forms an air gap. In a first embodiment of the invention, a radial gap ranging from 1 mm to 6 mm, preferably from 2 mm to 5 mm and particularly advantageously of 3 mm is provided. Due to this width of the gap, heat generation and hence the temperature increase in the shock-absorbing element is limited to 300° C. to 600° C., preferably to 400° C. to 500° C., since the shock-absorbing element performs its damping work substantially only at the moment of the fan blade loss and during the passage through at least one resonance frequency and only heats up while it is doing so.

In an advantageous development of the invention, the shock-absorbing element can be cooled with oil from the bearing chamber, where overflow oil from the fan bearing is passed radially into the shock-absorbing element or alternatively the shock-absorbing element can be cooled separately with spray oil. The temperature reduction due to cooling of the shock-absorbing element with oil can be between 10° C. and 50° C.

In an alternative embodiment of the invention, a relatively large gap of, for example, 6 mm to 12 mm can be provided. As a result, an imbalance load directly after a fan blade loss is effectively damped. An increased imbalance load peak during passage through a bending natural frequency while the gas turbine engine is shut down or after shutting down in continued flight of the aircraft is also effectively damped by this measure.

In accordance with the invention, the shock-absorbing element is designed as a metal fabric damper having a progressive spring characteristic, which in the event of a low radial deflection of the fan rotor has a low spring force and damping and hence low heat generation, but in the event of a high radial deflection of the fan rotor has a high spring force and damping and hence high heat generation. High radial deflections of the fan rotor at the moment of the fan blade loss and during passage through resonance frequencies can thus be effectively damped, but heat generation in the shock-absorbing element in all other time phases can be prevented or at least limited to a low level.

In a further alternative embodiment of the invention, the shock-absorbing element can be designed as a combination of at least two shock-absorbing elements with differing damping characteristics, with the radially inner shock-absorbing element having a lower spring stiffness than the radially outer shock-absorbing element.

In a further alternative embodiment of the invention, the shock-absorbing element can be designed as a metal fabric damper with spring stiffness increasing from radially inside to radially outside. This can be achieved by increasing compression of the metal fabric from radially inside to radially outside.

The term ‘radial’ relates to the engine axis of the aircraft gas-turbine engine.

In a further alternative embodiment of the invention, the shock-absorbing element can be designed as a combination of a shock-absorbing element with a plastically deforming structural element. Said plastically deforming structural element absorbs here part of the imbalance force occurring directly after a fan blade loss by means of plastic deformation.

In a preferred embodiment of the invention, it is furthermore provided that at least one acceleration sensor, which is connected to an engine control, is arranged in the area of the shock-absorbing element, fan bearing structure or engine structure. The acceleration sensor allows a fan blade loss to be detected, which then leads to shutdown of the engine. The shock-absorbing element can be designed here for short-time operation until a sufficient reduction of the fan speed and of the imbalance force thus introduced into the engine structure has occurred. Large vibration amplitudes occurring during rundown of the engine or after rundown of the fan rotor can thus optionally be additionally damped by the shock-absorbing element.

The imbalance force occurring at the fan bearing after a fan blade loss is thus damped at the fan bearing itself by the shock-absorbing element in accordance with the invention. A low-pressure rotor connected to the fan/fan rotor is centered here using a secondary bearing of the low-pressure rotor in the engine axis.

The present invention is described in the following in light of the accompanying drawing, showing exemplary embodiments. In the drawing,

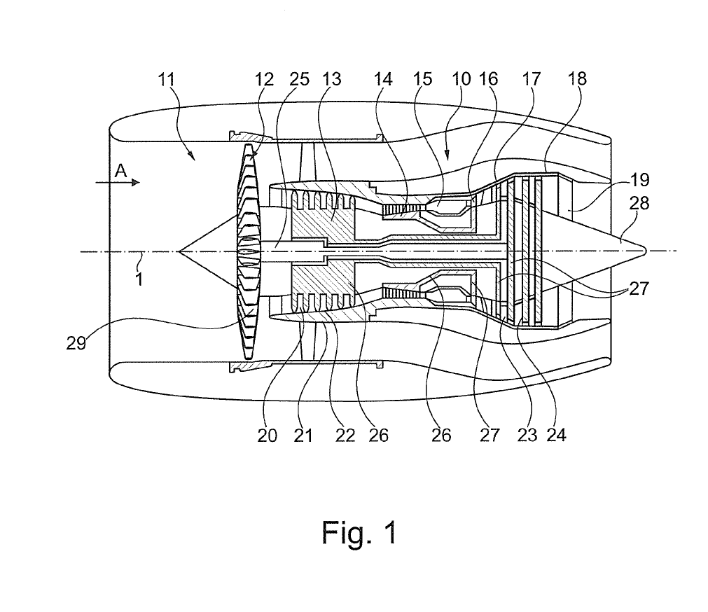

FIG. 1 shows a schematic representation of a gas-turbine engine in accordance with the present invention,

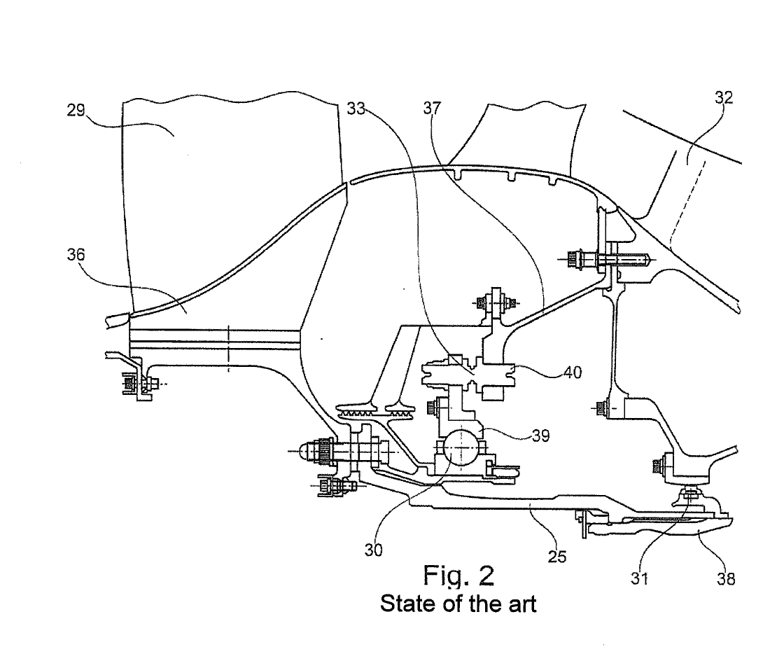

FIG. 2 shows a schematic detail view of an embodiment of the fan bearing in accordance with the state of the art,

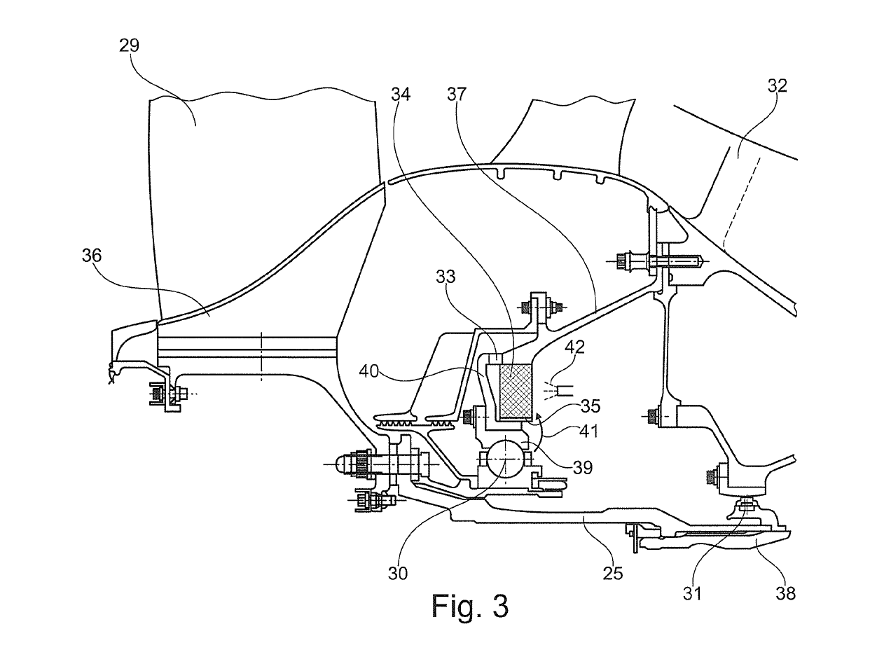

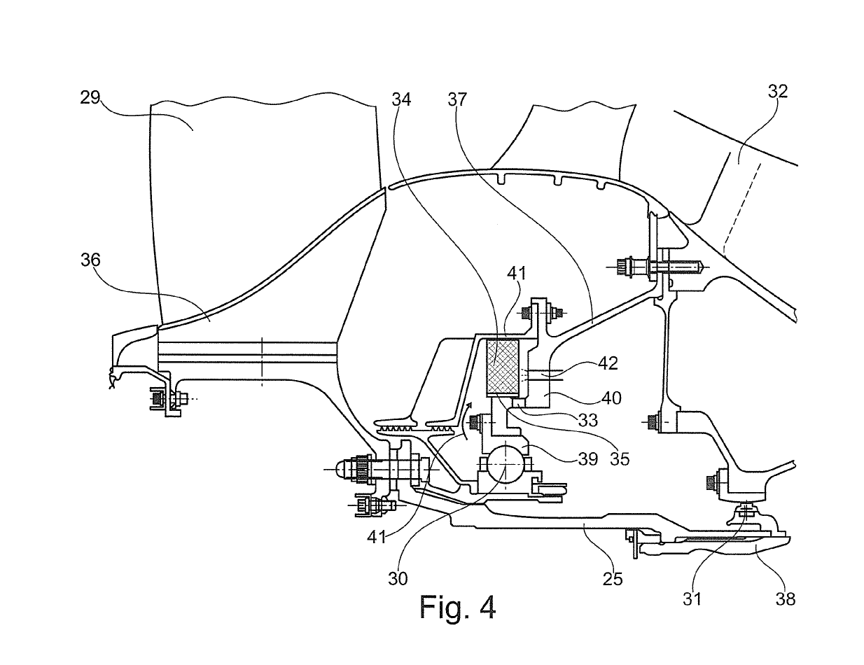

FIGS. 3 and 4 show representations, by analogy with FIG. 2, in modified exemplary embodiments of the present invention,

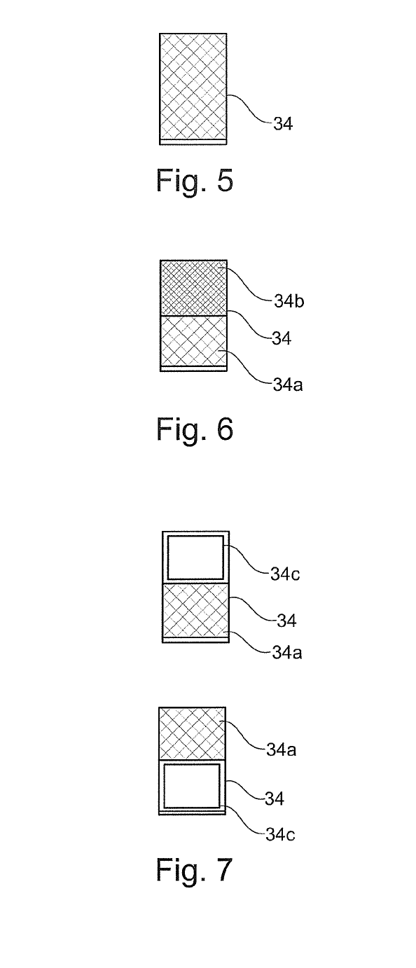

FIG. 5 shows a schematic representation of a shock-absorbing element,

FIG. 6 shows a schematic representation of a shock-absorbing element as a combination of two shock-absorbing elements with differing damping characteristics, and

FIG. 7 shows a schematic representation of a shock-absorbing element in combination with a plastically deforming structural element.

The gas-turbine engine 10 in accordance with FIG. 1 is a generally represented example of a turbomachine where the invention can be used. The engine 10 is of conventional design and includes in the flow direction, one behind the other, an air inlet 11, a fan 12 rotating inside a casing, an intermediate-pressure compressor 13, a high-pressure compressor 14, a combustion chamber 15, a high-pressure turbine 16, an intermediate-pressure turbine 17 and a low-pressure turbine 18 as well as an exhaust nozzle 19, all of which being arranged about a center engine axis 1.

The intermediate-pressure compressor 13 and the high-pressure compressor 14 each include several stages, of which each has an arrangement extending in the circumferential direction of fixed and stationary guide vanes, generally referred to as stator vanes 20 and projecting radially inwards from the core engine casing 21 in an annular flow duct through the compressors 13, 14. The compressors furthermore have an arrangement of compressor rotor blades 22 which project radially outwards from a rotatable drum or disk 26 linked to hubs 27 of the high-pressure turbine 16 or the intermediate-pressure turbine 17, respectively.

The turbine sections 16, 17, 18 have similar stages, including an arrangement of fixed stator vanes 23 projecting radially inwards from the casing 21 into the annular flow duct through the turbines 16, 17, 18, and a subsequent arrangement of turbine rotor blades 24 projecting outwards from a rotatable hub 27. The compressor drum or compressor disk 26 and the blades 22 arranged thereon, as well as the turbine rotor hub 27 and the turbine rotor blades 24 arranged thereon rotate about the engine axis 1 during operation.

FIG. 2 shows an embodiment according to the state of the art. It illustrates in simplified form a fan rotor 36 on which fan blades 29 are fastened in the usual way. The fan rotor 36 is connected to a fan shaft 25 which is mounted on a fan bearing structure 37 using a fan bearing 30 and hence on an engine structure 32. At the rear end area—seen in the flow direction—of the fan shaft 25, the latter is connected to a low-pressure shaft 38 (low-pressure rotor), which is mounted on the engine structure 32 by means of a bearing 31. FIG. 2 shows the embodiment according to the state of the art in a simplified schematic form.

An outer bearing ring 39 is connected to the fan bearing structure 37 via a coupling element 40. The coupling element 40 has at least one predetermined breaking point 33, which breaks in the event of an imbalance occurring, for example due to a fan blade loss. As a result, the fan rotor 36 can rotate about a new center of gravity resulting from the imbalance.

FIGS. 3 and 4 show exemplary embodiments of the solution in accordance with the invention. In these exemplary embodiments, at least one shock-absorbing element 34 is arranged to have a parallel effect relative to the respective predetermined breaking point 33, and can for example be designed as a ring. It is however also possible to design the shock-absorbing element as a ring interrupted at least once or as individual shock-absorbing elements arranged around the circumference.

In the exemplary embodiment shown in FIG. 3, the shock-absorbing element 34 is integrated directly into the fan bearing structure 37, which is provided with the predetermined breaking point 33. A radial gap 35 is provided between the shock-absorbing element 34 and a radially inner area of the coupling element 40.

In the exemplary embodiment shown in FIG. 4, the shock-absorbing element 34 is arranged between a radially inner area of the coupling element 40 and a bearing element 41 connected to the fan bearing structure 37.

FIGS. 3 and 4 furthermore show in schematic form a cooling of the shock-absorbing element 34 with overflow oil 41 of the fan bearing 30 and alternatively a cooling with spray oil 42.

FIGS. 5 to 7 each show sectional views of exemplary embodiments of the shock-absorbing element 34 in accordance with the invention. FIG. 5 shows a shock-absorbing element 34 having an identical material over its cross-section. FIG. 6 shows an exemplary embodiment including shock-absorbing elements 34a and 34b with differing damping characteristics. FIG. 7 shows variations with a shock-absorbing element 34a and a structural element 34c whose material is plastically deformable. The shock-absorbing element 34a is here softer than the shock-absorbing element 34b. Alternatively, the shock-absorbing elements 34a and 34b can be designed as areas of the shock-absorbing element 34 with differing degrees of compression.

### LIST OF REFERENCE NUMERALS

1 Engine axis

10 Gas-turbine engine/core engine

11 Air inlet

12 Fan

13 Intermediate-pressure compressor (compressor)

14 High-pressure compressor

15 Combustion chamber

16 High-pressure turbine

17 Intermediate-pressure turbine

18 Low-pressure turbine

19 Exhaust nozzle

20 Stator vanes

21 Core engine casing

22 Compressor rotor blades

23 Stator vanes

24 Turbine rotor blades

25 Fan shaft

26 Compressor drum or disk

27 Turbine rotor hub

28 Exhaust cone

29 Fan blade

30 Fan bearing

31 Bearing

32 Engine structure

33 Predetermined breaking point

34 Shock-absorbing element

34a Shock-absorbing element with first damping characteristics

34b Shock-absorbing element with further damping characteristics

34c Plastically deforming structural element

35 Gap

36 Fan rotor

37 Fan bearing structure

38 Low-pressure shaft

39 Outer bearing ring

40 Coupling element

41 Overflow oil from the fan bearing

42 Spray oil for cooling the shock-absorbing element

1. An aircraft gas-turbine engine having a fan mounted on a fan shaft and including several fan blades, where the fan shaft is mounted on an engine structure by means of an upstream fan bearing, when seen in the flow direction, and a downstream bearing, where at least one predetermined breaking point is provided in the area of the fan bearing, wherein at least one shock-absorbing element designed as metal fabric damper is arranged at a radial gap to have a parallel effect relative to the predetermined breaking point.

2. The aircraft gas-turbine engine in accordance with claim 1, wherein the predetermined breaking point and the shock-absorbing element are arranged on the radially outer side of the fan bearing facing the engine structure.

3. The aircraft gas-turbine engine in accordance with claim 1, wherein the shock-absorbing element is designed as a combination of two shock-absorbing elements with differing damping characteristics.

4. The aircraft gas-turbine engine in accordance with claim 1, wherein the shock-absorbing element is designed as a one-piece shock-absorbing element, which has two areas of differing damping characteristics.

5. The aircraft gas-turbine engine in accordance with claim 1, wherein the shock-absorbing element is designed as a combination of a shock-absorbing element with a plastically deforming structural element.

6. The aircraft gas-turbine engine in accordance with claim 1, wherein the radial gap is provided between the fan bearing and the shock-absorbing element.

7. The aircraft gas-turbine engine in accordance with claim 6, wherein the gap is provided with a width ranging from 1 mm to 6 mm, preferably from 2 mm to 5 mm and particularly advantageously with a width of 3 mm.

8. The aircraft gas-turbine engine in accordance with claim 6, wherein the gap is provided with a width ranging from 6 mm to 12 mm.

9. The aircraft gas-turbine engine in accordance with claim 1, wherein at least one acceleration sensor, which is connected to an engine control, is arranged in the area of the shock-absorbing element, fan bearing structure or engine structure.

10. The aircraft gas-turbine engine in accordance with claim 1, wherein the shock-absorbing element is designed as a ring, as an interrupted ring or as several shock-absorbing elements distributed over the circumference.

11. The aircraft gas-turbine engine in accordance with claim 1, wherein means for the supply of oil for cooling the shock-absorbing element are assigned to the shock-absorbing element.

12. The aircraft gas-turbine engine in accordance with claim 1, wherein means for the supply of overflow oil from the fan bearing or of spray oil are provided.
